(19) United States
(12) Patent Application Publication
(10) Pub. No.: US 2001/0031590 A1
(43) Pub. Date: Oct. 18, 2001

(54) Wning fabric and process for producing same

(76) Inventor: Wolfgang Schulz, Steinfurt (Borghorst) (DE)

Correspondence Address: BROWDY AND NEIMARK, P.L.L.C., 624 NINTH STREET, NW, SUITE 300, WASHINGTON, DC, 20001-5303, US

(21) Appl. No.: 09/826,369

(22) Filed: Apr. 5, 2001

(30) Foreign Application Priority Data
Apr. 14, 2000 (DE) 100 18 484.7

(51) Int. Cl. B32B 5/02; B32B 27/04; B32B 27/12; B32B 27/02

(52) U.S. Cl. 442/132; 442/131; 442/164

(57) ABSTRACT

In an awning fabric, to attain good UV stability and weather resistance with the lowest possible weight per unit area, provision is made for it to be produced from polyester (PES) filament yarn (continuous filament yarn) and/or polyester monofilament yarn.

### BACKGROUND OF THE INVENTION

1. Field of the Invention

The present invention is directed to an awning fabric and a process for producing same, as well as to an awning having such an awning fabric.

2. Background Art

Great demands are placed on awning fabrics regarding their UV light-fastness, resistance to tearing, weather resistance and water and dirt repellency. Conventionally, they are, therefore, produced from spin-dyed polyacrylnitrile (PAC) filaments using strong yarn with a count of Nm 34×2 (dtex 588). To attain good water repellency and sharply defined longitudinal stripes in the pattern, approximately 30 warp threads/cm and approximately 15 weft threads/cm are used. The corresponding woven cloth is then provided with stiffening and water-repellent artificial resins.

In some cases it has also been attempted to use other types of filament fabrics, which, however, did not gain acceptance, mainly because of the lacking UV stability of the filaments and dyes. The weight per unit area of these fabrics was 300 g/sqm and above.

Based on the above as a starting-point, the invention has as its object to create an awning fabric that has the lowest possible weight per unit area while providing good UV stability and weather resistance.

This object is met according to the invention in such a way that it is produced from polyester (PES) filament yarn (continuous filament yam). The heart of the invention thus consists of the fact that one uses not only polyester yarn, which is not customarily used, but specifically uses the same in the form of a continuous filament yarn in lieu of the customary staple filament yarn.

With a continuous filament yam of this type, the surface becomes much smoother, which counteracts soiling. The polyester yam results in a very high resistance to tearing. A very high resistance to UV rays is furthermore ensured based on the fact that polyester filament yam has a round cross-section, that delustrants and lubricants, which normally form a nucleus for the degradation of filaments by UV rays, are used in minute quantities in the filaments, preferably less than 0.05%. Conventionally, this percentage is 1.5% for mat filament types and 0.3-0.5% for semi-mat filament types. Provision is preferably made for the weft density to be 35 to 50 threads/cm and the warp rate to be 20 to 25 threads/cm.

A weight per unit area that is preferable and attainable within the framework of the invention is 200 to 250 g/sqm. Based on this low weight per unit area, the awning fabric wraps around the cloth cover of the awning with a lesser thickness and permits a wider distance between seams than the 120 cm that have been customary until now. This results in a more inexpensive assembly of the awning cloth and the entire awning can be built slimmer. The known, so-called “Christmas-tree effect” that is caused by the superposed thickness of seam areas wound on top of one another, is counteracted. Provision is preferably made for the awning fabric to have a weight per unit area of 200 to 250 g/sqm. The weight per unit area is thus considerably lower than that of conventional awning fabrics, the weight of which is over 300 g/sqm.

The awning fabric is advantageously wet-dyed, preferably with an anthraquinone-based disperse dye. The disperse dyes that are used are nitro dyes, azo dyes and anthraquinone dyes. This means that the customary spin dyeing during primary spinning is not used in this case, but the dyeing takes place in an aqueous solution at the processor's, thus permitting a significant broadening of the usually limited color range.

Furthermore, a UV block is advantageously provided, which permits the inventive polyester yams to be dyed wet in the required fastness. Suitable UV blocks for this are those that are triazine-derivative based. This UV block may be applied in the dye bath.

The invention is also directed to a process for producing an awning fabric whereby provision is made for the same to be woven from polyester filament yam, wet-dyed and set in a tenter at a temperature of approximately 185° C. As a delustrant and lubricant, titanium dioxide is introduced into the fiber in a quantity of less than 0.05%.

A further subject matter of the invention is an awning with the above-described awning fabric.

### DESCRIPTION OF THE PREFERRED EMBODIMENTS

The invention is described in further detail below, based on preferred embodiments.

Embodiment 1:

Warp rate: 38.5 threads/cm, PES filament dtex 167/2

Weft density: 22.0 threads/cm, PES filament yam dtex 167/2

Weight per unit area approximately 235 g/sqm

Embodiment 2:

Warp rate: 46.5 threads/cm, PES filament dtex 110/2

Weft density: 21.0 threads/cm, PES filament yarn dtex 167/2

Weight per unit area approximately 200 g/sqm.

In both embodiments the awning fabric obtained in this manner is wet-dyed with anthraquinone-based disperse dyes. A UV block on a triazine-derivative basis is added to the dye bath. The fabric is then set in a tenter at high temperatures and subsequently cooled off. Tensions are thus fixed in the fabric.

What is claimed is:

1. An awning fabric, wherein it is made from polyester (PES) filament yarn (continuous filament yarn) and/or polyester monofilament yam.

2. An awning fabric according to claim 1, wherein it has a weight per unit area of 200 to 250 g/sqm.

3. An awning fabric according to claim 1, wherein it is wet-dyed, particularly by means of an anthraquinone-based disperse dye.

4. An awning fabric according to claim 1, wherein a UV block is provided.

5. An awning fabric according to claim 4, wherein the UV block is triazine-derivative based.

6. An awning fabric according to claim 5, wherein the polyester yarn is round.

7. A method for producing an awning fabric according to claim 1, wherein it is woven from polyester filament yarn and/or polyester monofilament yarn.

8. A method for producing an awning fabric according to claim 7, wherein it is wet-dyed.

9. A method for producing an awning fabric according to claim 7, wherein it is set in a tenter at a temperature of approximately 185°.

10. A method for producing an awning fabric according to claim 7, wherein titanium dioxide is introduced into the filament as a delustrant and lubricant in a quantity of less than 0.05%.

11. An awning, particularly an awning with articulated arms or a sun room awning comprising an awning fabric according to claim 1.
